(19) United States
(12) Patent Application Publication
(10) Pub. No.: US 2010/0193136 A1
(43) Pub. Date: Aug. 5, 2010

(54) ASSEMBLY OF UNITS FOR BUILDING AN UNVULCANISED OR GREEN TYRE FOR VEHICLES

(76) Inventor: Henk-Jan Grolleman, Eerbeek (NL)

Correspondence Address: LADAS & PARRY LLP, 26 WEST 61ST STREET, NEW YORK, NY, 10023, US

(21) Appl. No.: 12/663,017

(22) PCT Filed: Dec. 11, 2008
(86) PCT No.: PCT/NL2008/050793

§ 371 Date: Apr. 19, 2010

Related U.S. Application Data
(60) Provisional application No. 61/007,100, filed on Dec. 11, 2007.

(30) Foreign Application Priority Data
Dec. 11, 2007 (NL) 2001071

(51) Int. Cl. B29D 30/20; B29D 30/24; B29D 30/26

(52) U.S. Cl. 156/396

(57) ABSTRACT

Assembly of units for building a vehicle tyre. The assembly has a first unit (1) having a breaker building drum (2), a second unit (5) having a carcass building drum (6), a third unit (9) having a shaping drum (10), a breaker ply supply unit (14) for supplying breaker plies to the breaker building drum (2), a carcass material supply unit (15) for supplying carcass material to the carcass drum (6), a first transportation rail (16) which, considered in vertical direction, is placed below the shaping drum (10) and the carcass building drum (6), a unit (17) for retaining and positioning beads, a first breaker transfer ring (21) and a second carcass transfer ring (22) movably placed on the transportation rail (16). The assembly further comprises a second transportation rail (24) extending spaced apart from and parallel to the first transportation rail (16) and placed adjacent to the carcass building drum (6), a number of arrangement units (25) for arranging rubber material, wound on a roll (26), on the carcass building drum (6), wherein the arrangement units (25) can be moved over the second transportation rail (24).

### BACKGROUND OF THE INVENTION

The invention relates to an assembly of units for building an unvulcanised or green tyre for vehicles, wherein the assembly is provided with a first unit having a breaker building drum, a drive for the breaker building drum and a stitcher for stitching breaker material to be arranged on the breaker building drum, a second unit having a carcass building drum, a drive for the carcass building drum and a stitcher for stitching carcass material to be arranged on the carcass building drum, a third unit having a shaping drum, a drive for the shaping drum, a support for the shaping drum, and a stitcher for stitching tyre material to be arranged on the shaping drum, a breaker ply supply unit for supplying breaker plies to the breaker building drum, a carcass material supply unit for supplying carcass material to the carcass building drum, a first transportation rail, wherein the first transportation rail considered in vertical direction is placed below the shaping drum and the carcass building drum, a unit for retaining and positioning beads, which unit comprises bead placement devices, that are movably placed on the first transportation rail for supplying beads to a carcass drum, and a bead loading device, a first breaker transfer ring movably placed on the first transportation rail, a second carcass transfer ring movably placed on the first transportation rail, and a removing unit for removing a green tyre.

Such an assembly is for instance known from European patent specification EP-B1-0.880.436. Although such an assembly as regards the type of tyre to be manufactured is relatively flexible and of a high production capacity, it has turned out that particularly in case of manufacturing tyres intended for vehicles that are often used off the road, the known assembly is not sufficiently flexible. Said so-called off-the-road tyres intended for vehicles that can be used off the road often have relatively large dimensions and many tyre components, that may differ per tyre to quite some extent. Due to said many different components an assembly of units for manufacturing them is relatively bulky and the logistics, particularly supplying the various tyre components to the units is a relatively great problem.

### SUMMARY OF THE INVENTION

It is among others an object of the invention to provide an assembly of units for building an unvulcanised or green tyre, particularly off-the-road tyres, for vehicles which assembly is relatively compact, offers a high flexibility for manufacturing tyres of different types and wherein the logistics, and with which a relatively high production capacity can be achieved and the supply of the various tyre components can be simplified.

To that end an assembly of the type mentioned in the preamble is according to the invention characterised in that the assembly is furthermore provided with a second transportation rail, wherein the second transportation rail extends spaced apart from and parallel to the first transportation rail and is placed adjacent to the carcass building drum, a number of arrangement units for arranging rubber material, such as a chaffer, wound on a roll, on the carcass building drum, wherein the arrangement units can be moved over the second transportation rail. By using a second transportation rail over which arrangement units for rubber material wound on a roll can be moved, the assembly of units can be designed relatively compact, and in a relatively flexible manner various tyre components can be used for manufacturing a green tyre. The second transportation rail also simplifies the logistics.

A further improvement of the flexibility and the logistics can be achieved when the second transportation rail at one side extends to beyond the first transportation rail, and when the assembly is provided with a unit for arranging pre-cut rubber material, which unit is provided with a number of supply conveyors for supplying pre-cut rubber material, and a number of arrangement conveyors for picking up pre-cut rubber material supplied by the supply conveyors and for arranging the pre-cut rubber material on the carcass building drum, wherein the arrangement conveyors can be moved over the second transportation rail.

A yet further improvement of the flexibility and the logistics can be achieved when the carcass material supply unit is provided with a first member and a second member, with a third transportation rail placed between the first member and the second member, and with a transfer conveyor for transferring carcass material from the first member to the second member, wherein the transfer conveyor can be moved over the third transportation rail.

A yet further improvement of the flexibility and the logistics can be achieved when the first member comprises a number of adjacently situated sub members, wherein each sub member is intended for supplying an own carcass material.

A yet further improvement of the flexibility and the logistics can be achieved when the breaker ply supply unit is provided with a rotatable carousel having a number of supply devices for supplying rubber material wound on a roll, a cutting unit having a cutting device and a cutting conveyor for picking up rubber material supplied by a supply device, and a supply conveyor for supplying cut rubber material supplied by the cutting conveyor to the breaker building drum.

The production capacity can furthermore be improved when the breaker building drum can be moved transverse to the first transportation rail between a position vertically above the first transportation rail and a position spaced apart adjacent to the first transport rail.

### SHORT DESCRIPTION OF THE DRAWINGS

The invention will be elucidated on the basis of an exemplary embodiment shown in the attached drawing, in which:

FIG. 1 schematically shows an arrangement of an assembly of units for building an unvulcanised or green tyre for vehicles.

### DETAILED DESCRIPTION OF THE DRAWINGS

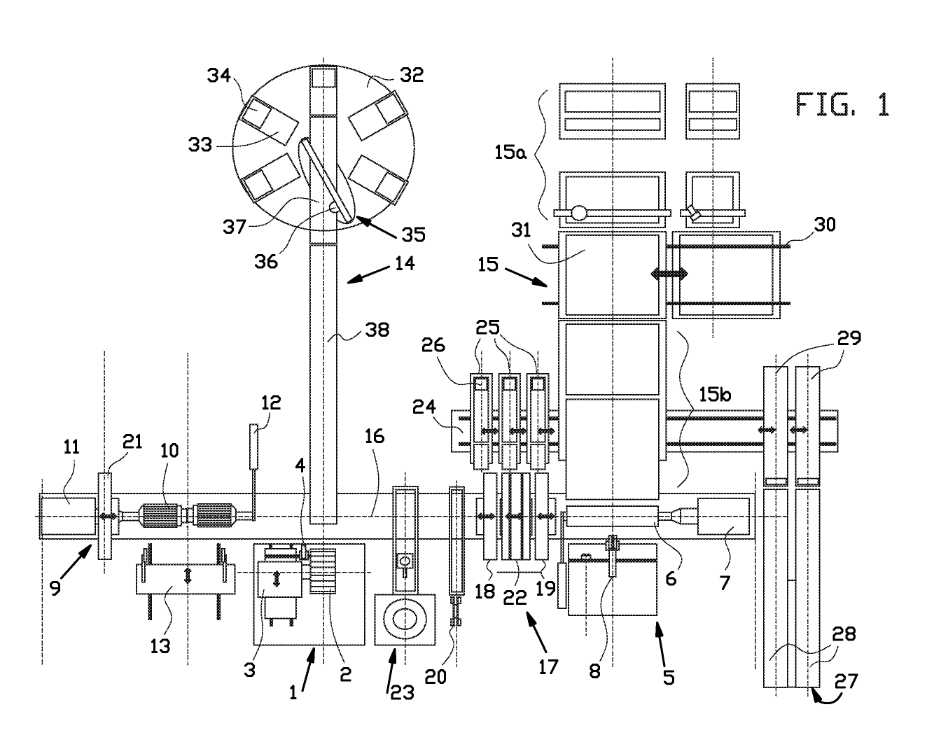

FIG. 1 schematically shows an exemplary arrangement of an assembly of units for building an unvulcanised or green tyre for vehicles. The assembly is particularly suitable for building a so-called off-the-road tyre.

The assembly comprises a first unit 1 having a breaker building drum 2, a drive 3 for the breaker building drum 2 and a stitcher 4 for stitching breaker material to be arranged on the breaker building drum 2. The breaker building drum 2 can be moved transverse to a first transportation rail 16 (to be discussed further below) between a position vertically above the first transportation rail 16 and a position spaced apart adjacent to the first transportation rail 16. Such a breaker building drum is known per se and therefore will not be discussed in further detail here.

The assembly furthermore comprises a second unit 5 having a carcass building drum 6, a drive 7 for the carcass building drum 6 and a stitcher 8 for stitching carcass material to be arranged on the carcass building drum 6. Such a carcass building drum is known per se and therefore will not be discussed in further detail here.

The assembly further comprises a third unit 9 having a shaping drum (also called building drum) 10, a drive 11 for the shaping drum 10, a support 12 for the shaping drum 10, and a stitcher 13 for stitching the tyre material to be arranged on the shaping drum 10. Such a building drum is known per se and therefore will not be discussed in further detail here.

The assembly is furthermore provided with a breaker ply supply unit 14 for supplying breaker plies to the breaker building drum 2, and a carcass material supply unit 15 for supplying carcass material to the carcass drum 6. In a manner known per se the supply units may comprise one or several conveyors, such as belt conveyors, roller conveyors or the like.

Considered in vertical direction the first transportation rail 16 of the assembly is placed below the shaping drum 10 and the carcass building drum 6.

The assembly furthermore comprises a unit 17 for retaining and positioning beads, which unit 17 comprises bead placement devices 18, 19, that are movably placed on the first transportation rail 16 for supplying beads to a carcass drum, and a bead loading device 20. Such a bead placement unit is known per se and therefore will not be discussed in further detail here.

The assembly furthermore comprises a first breaker transfer ring 21, movably mounted on the first transportation rail 16, a second carcass transfer ring 22 movably mounted on the first transportation rail 16. Such transfer rings are known per se and therefore will not be discussed in further detail here. According to an individual aspect of the invention the bead placement devices 18, 19 can be detachably coupled to the carcass transfer ring 22. Thus an improvement of the production capacity can be realised.

The assembly is furthermore provided with a removing unit 23 for removing a green tyre that is ready. Such a removing unit is known per se and therefore will not be discussed in further detail here.

By using a second transportation rail 24, which extends spaced apart from and parallel to the first transport rail 16 and is placed adjacent to the carcass building drum 6, and a number of arrangement units 25 for arranging rubber material, such as a chaffer, wound on a roll 26, on the carcass building drum 6, which arrangement units 25 are arranged so as to be movable over the second transportation rail 24, the flexibility of the assembly is strongly increased.

As shown in the exemplary embodiment depicted in FIG. 1, the second transportation rail 24 at one side extends to beyond the first transportation rail 16. At said side the assembly is provided with a unit 27 for arranging pre-cut rubber material.

Said unit 27 is provided with a number of supply conveyors 28 for supplying pre-cut rubber material, and with a number of arrangement conveyors 29 for picking up pre-cut rubber material supplied by the supply conveyors. The arrangement conveyors are also intended for arranging the pre-cut rubber material on the carcass building drum 6. These arrangement conveyors 29 as well can be moved over the second transportation rail 24, as a result of which on the one hand the flexibility of the assembly is strongly increased but the compactness is also preserved.

As shown in the exemplary embodiment depicted in FIG. 1, the carcass material supply unit 15 is built up from a first member 15a and a second member 15b. A third transportation rail 30 is placed between the first member 15a and the second member 15b. A transfer conveyor 31 for transferring carcass material from the first member 15a to the second member 15b, is arranged so as to be movable over the third transportation rail 30. In the exemplary embodiment shown the first member 15a comprises a number of adjacently situated sub members, wherein each sub member is intended for supplying its own carcass material. In that way it is possible that each member (15a and 15b, respectively) supply a different type of carcass material to the carcass building drum, without a lot of space being taken up for that purpose. In the embodiment shown the number of members is two, yet it will be clear to an expert that any other number can be applied within the scope of the invention.

The breaker ply supply unit 14 comprises a rotatable carousel 32 having a number of supply devices 33, in the exemplary embodiment shown six although any other number can also be applied, for supplying rubber material wound on a roll 34. The breaker ply supply unit further comprises a cutting unit 35 having a cutting device 36 and a cutting conveyor 37 for picking up rubber material supplied by a supply device 33. For transportation to the cutting conveyor the supply device 33 may comprise a supply conveyor or table connecting to the roll. The cutting conveyor 37 supplies the cut rubber material to a supply conveyor 38 which in turn is intended for supplying cut rubber material to the breaker building drum 2.

The assembly described above provides a compact and flexible assembly for building tyres having relatively many parts, wherein many of said parts are supplied to the carcass building drum in a simple manner by the second transportation rail over which several arrangement units (25, 29) can be moved. Because of the third transportation rail and the transfer conveyor 31 and because of the carousel 32 (for various breaker materials, for instance having different angles) the flexibility of the assembly is further improved. Due to using the carousel only one, preferably, automatically adjustable cutting device and one supply conveyor 38 are needed. For arranging rubber components on the building drum 10 several arrangement units are available, which are supplied via the various units (14, 15, 17, 27). In that case the second and third transportation rails and the carousel render a compact assembly possible, as a result of which the rubber components can quickly be assembled into a green tyre, in which way undesired vulcanisation of the rubber components due to unnecessary storage can be prevented to a large degree.

The above description is included to illustrate the operation of preferred embodiments of the invention and not to limit the scope of the invention. Starting from the above explanation many variations that fall within the spirit and scope of the present invention will be evident to an expert.

1. Assembly of units for building an unvulcanized or green tyre for vehicles, wherein the assembly is provided with:
a first unit (1) having a breaker building drum (2), a drive (3) for the breaker building drum (2) and a stitcher (4) for stitching breaker material to be arranged on the breaker building drum (2)
a second unit (5) having a carcass building drum (6), a drive (7) for the carcass building drum (6) and a stitcher (8) for stitching carcass material to be arranged on the carcass building drum (6),
a third unit (9) having a shaping drum (10), a drive (11) for the shaping drum (10), a support (12) for the shaping drum (10), and a stitcher (13) for stitching tyre material to be arranged on the shaping drum (10),
a breaker ply supply unit (14) for supplying breaker plies to the breaker building drum (2),
a carcass material supply unit (15) for supplying carcass material to the carcass building drum (6),
a first transportation rail (16), wherein the first transportation rail (16) considered in vertical direction is placed below the shaping drum (10) and the carcass building drum (6),
a unit (17) for retaining and positioning beads, which unit (17) comprises bead placement devices (18, 19), that are movably placed on the first transportation rail (16) for supplying beads to a carcass drum, and a bead loading device (20),
a first breaker transfer ring (21) movably placed on the first transportation rail (16), a second carcass transfer ring (22) movably placed on the first transportation rail (16), and
a removing unit (23) for removing a green tyre,
characterised in that the assembly is furthermore provided with
a second transportation rail (24), wherein the second transportation rail (24) extends spaced apart from and parallel to the first transportation rail (16) and is placed adjacent to the carcass building drum (6),
a number of arrangement units (25) for arranging rubber material, such as a chaffer, wound on a roll (26), on the carcass building drum (6), wherein the arrangement units (25) can be moved over the second transportation rail (24).

2. Assembly according to claim 1, wherein the second transportation rail (24) at one side extends to beyond the first transportation rail (16), and wherein the assembly is provided with a unit (27) for arranging pre-cut rubber material, which unit (27) is provided with a number of supply conveyors (28) for supplying pre-cut rubber material, and a number of arrangement conveyors (29) for picking up pre-cut rubber material supplied by the supply conveyors and for arranging the pre-cut rubber material on the carcass building drum (6), wherein the arrangement conveyors (29) can be moved over the second transportation rail.

3. Assembly according to claim 1, wherein the carcass material supply unit (15) is provided with a first member (15a) and a second member (15b), with a third transportation rail (30) placed between the first member (15a) and the second member (15b), and with a transfer conveyor (31) for transferring carcass material from the first member (15a) to the second member (15b), wherein the transfer conveyor (31) can be moved over the third transportation rail (30).

4. Assembly according to claim 3, wherein the first member (15a) comprises a number of adjacently situated sub members, wherein each sub member is intended for supplying an own carcass material.

5. Assembly according to claim 1, wherein the breaker ply supply unit (14) is provided with a rotatable carousel (32) having a number of supply devices (33) for supplying rubber material wound on a roll (34), a cutting unit (35) having a cutting device (36) and a cutting conveyor (37) for picking up rubber material supplied by a supply device {33), and a supply conveyor (38) for supplying cut rubber material supplied by the cutting conveyor (37) to the breaker building drum (2).

6. Assembly according to claim 1, wherein the breaker building drum (2) can be moved transverse to the first transportation rail (16) between a position vertically above the first transportation rail {16) and a position spaced apart adjacent to the first transportation rail (16).
